(19) United States
(12) Patent Application Publication
(10) Pub. No.: US 2019/0152455 A1
(43) Pub. Date: May 23, 2019

(54) Pressure Pulsation Reducing Device and Pulsation Damping Member of Hydraulic System

(71) Applicant: Hitachi Automotive Systems, Ltd., Hitachinaka-shi, Ibaraki (JP)

(72) Inventors: Ryu KAI, Tokyo (JP); Takahiro ITO, Tokyo (JP); Shinji SETO, Tokyo (JP); Atsushi YOKOYAMA, Tokyo (JP); Satoru KURAGAKI, Hitachinaka-shi (JP); Toshihiro KOIZUMI, Hitachinaka-shi (JP)

(21) Appl. No.: 16/098,188

(22) PCT Filed: Feb. 6, 2017
(86) PCT No.: PCT/JP2017/004215

§ 371 Date: Nov. 1, 2018

(30) Foreign Application Priority Data
May 13, 2016 (JP) 2016-096907

(51) Int. Cl. B60T 8/40; F16J 3/02; F16L 55/04

(52) U.S. Cl. CPC B60T 8/4068; F16D 2125/12; F16L 55/041; F16J 3/02

(57) ABSTRACT

Provided is a novel pressure pulsation reducing device of a hydraulic system that reduces a stress generated in a metal diaphragm and is excellent in durability. A plurality of concentric recess portions projecting toward an interior space of a pulsation damping member is formed on one of metal diaphragms, and a plurality of concentric recess portions projecting toward the interior space of the pulsation damping member is formed on the other metal diaphragm likewise. When a predetermined pressure is applied to the metal diaphragms, at least one recess portion of one of the metal diaphragms and at least one recess portion of the other metal diaphragm are in contact with each other.

### TECHNICAL FIELD

The present invention relates to a pressure pulsation reducing device and a pulsation damping member that damps pressure pulsation of fluid, and more particularly to a pressure pulsation reducing device and a pulsation damping member used in a hydraulic system.

### BACKGROUND ART

In an automobile and industrial machinery, a hydraulic system using hydraulic fluid as a medium is widely used. For example, in an automobile, a hydraulic brake system that operates a brake mechanism using a hydraulic pressure from a hydraulic pump is known. Besides, a hydraulic system of a transmission, a hydraulic system of a high-pressure fuel injection pump, and the like are known. Although a hydraulic brake system will be exemplified in the following descriptions, the present invention is not limited thereto, and can be adopted for pressure pulsation reducing devices of various hydraulic systems.

In the hydraulic brake system, a hydraulic pump that produces a hydraulic pressure is used, which periodically sucks and discharges a brake oil so that pressure pulsation occurs in the output hydraulic pressure. The pressure pulsation may be caused by various causes other than the above. The pressure pulsation adversely affects external environment. For example, in an automobile, the pressure pulsation results in mechanical vibration or noise, which gives a driver discomfort.

In view of the above, there has been proposed a hydraulic brake system in which a pressure pulsation reducing device is provided in a flow passage of hydraulic piping of the hydraulic brake system, which reduces pressure pulsation. For example, JP 2003-530531 A (PTL 1) discloses a pressure pulsation reducing device in which a pulsation damping member, which is configured by two metal diaphragms formed in concentric corrugated shapes that overlap each other and welding edge portions of both, is housed in a fluid chamber connected to hydraulic piping. The pulsation damping member of the pressure pulsation reducing device is configured by enclosing a gas having a predetermined pressure, which is not lower than atmospheric pressure, in the interior space of the two metal diaphragms. In general, at least one pulsation damping member is provided in the fluid chamber. In the descriptions below, a configuration of one pulsation damping member will be described.

When a hydraulic pressure is applied to the pulsation damping member including the two metal diaphragm from the outside, relative positions of movable portions of the two metal diaphragms are displaced, whereby interior volume of the pulsation damping member changes. As a result, the pulsation damping member acts to damp pressure pulsation of fuel inside the fluid chamber.

### CITATION LIST

### Patent Literature

PTL 1: JP 2003-530531 A

### SUMMARY OF INVENTION

### Technical Problem

Incidentally, in the pressure pulsation reducing device, durability becomes an issue as the number of operations increases. The pulsation damping member is displaced in a direction in which the movable portions of the two metal diaphragms move toward or away from each other in accordance with the pressure pulsation of the brake oil inside the fluid chamber, thereby entering a state where the interior volume of the pulsation damping member is repeatedly increased/decreased. Accordingly, when a stress generated in the metal diaphragm is large, the durability of the metal diaphragm is seriously impaired. In addition, frequencies of displacement of the metal diaphragm also largely affect an endurance period of the pulsation damping member.

In view of the above, in order to prolong the endurance period of the pulsation damping member including the metal diaphragm, it is conceivable to employ a special material having a long endurance period as a material for the metal diaphragm, for example. However, in a case where the special material having a long endurance period is used as a material of the metal diaphragm, there may be caused a problem that a product unit price of the pressure pulsation reducing device increases, which may cause a new problem that product competitiveness is hindered and is inadvisable. Therefore, it is required to improve the durability by minimizing the stress generated in the metal diaphragm.

An object of the present invention is to provide a pressure pulsation reducing device of a novel hydraulic system which reduces the stress generated in a metal diaphragm and is excellent in durability and a pulsation damping member used therein.

### Solution to Problem

A characteristic of the present invention is that in a pressure pulsation reducing device that stores, inside a fluid chamber connected to piping of a hydraulic control system, one or more pulsation damping member formed of a first metal diaphragm and a second metal diaphragm and provided with an interior space formed between the metal diaphragms, the first metal diaphragm has a first recess portion drawn toward the interior space side, and the second metal diaphragm has a first recess portion drawn toward the interior space side, the first recess portion having a curvature larger than a curvature of the first recess portion of the first metal diaphragm and being able to abut on the first recess portion of the first metal diaphragm.

Another characteristic of the present invention is that in the pressure pulsation reducing device, that stores, inside the fluid chamber connected to the piping of the hydraulic control system, one or more pulsation damping member formed of the two metal diaphragms and provided with the interior space formed between the metal diaphragms, a plurality of recess portions drawn toward the interior space of the pulsation damping member is formed on one of the metal diaphragms included in the pulsation damping member, a plurality of recess portions drawn toward the interior space of the pulsation damping member is formed on the other metal diaphragm included in the pulsation damping member, and in a case where a predetermined pressure is applied to the two metal diaphragms, at least one of the recess portions of one of the metal diaphragms and at least one of the recess portions of the other metal diaphragm are brought into contact with each other.

Still another characteristic of the present invention is that in the pulsation damping member that damps pressure pulsation of a hydraulic system, is formed of the first metal diaphragm and the second metal diaphragm, and is provided with the interior space formed between the metal diaphragms, the first metal diaphragm has the first recess portion drawn toward the interior space side, the second metal diaphragm has the first recess portion drawn toward the interior space side, the first recess portion having a curvature larger than a curvature of the first recess portion and being able to abut on the first recess portion of the first metal diaphragm, and in a case where a pressure applied to the outer surface of the first metal diaphragm and the second metal diaphragm reaches a first set pressure, the first recess portion of the first metal diaphragm and the first recess portion of the second metal diaphragm are brought into contact with each other.

### Advantageous Effects of Invention

According to the present invention, when the predetermined pressure is applied, one recess portion drawn toward the interior space side between the two metal diaphragms are brought into contact with each other, whereby the stress of the two metal diaphragms can be reduced and the durability can be enhanced. Moreover, no metal diaphragm made of a special material is required so that an increase in product unit price can be suppressed.

### BRIEF DESCRIPTION OF DRAWINGS

FIG. 1 is a configuration diagram illustrating a configuration of a hydraulic control unit of a hydraulic brake system to which the present invention is applied.

FIG. 2 is a partial cross-sectional view of a pulsation damping member used in a pressure pulsation reducing device according to a first embodiment of the present invention.

FIG. 3 is a top perspective view of the pulsation damping member illustrated in FIG. 2.

FIG. 4 is a first cross-sectional view for illustrating operation of the pulsation damping member illustrated in FIG. 2.

FIG. 5 is a second cross-sectional view for illustrating the operation of the pulsation damping member illustrated in FIG. 2.

FIG. 6 is an explanatory diagram illustrating a contact point between a first recess portion of a first metal diaphragm and a first recess portion of a second metal diaphragm.

FIG. 7 is a partial cross-sectional view of a pulsation damping member used in a pressure pulsation reducing device according to a second embodiment of the present invention.

FIG. 8 is a bottom perspective view of the pulsation damping member illustrated in FIG. 7.

FIG. 9 is a partial cross-sectional view of a pulsation damping member used in a pressure pulsation reducing device according to a third embodiment of the present invention.

FIG. 10 is a top perspective view of the pulsation damping member illustrated in FIG. 9.

FIG. 11 is a top view of a pulsation damping member used in a pressure pulsation reducing device according to a fourth embodiment of the present invention.

FIG. 12 is a cross-sectional view of the movement reducing member illustrated in FIG. 11 taken along line A-A.

FIG. 13 is a cross-sectional view of the pulsation damping member illustrated in FIG. 11 taken along line B-B.

FIG. 14 is a cross-sectional view of the pulsation damping member illustrated in FIG. 11 taken along line C-C.

FIG. 15 is a cross-sectional view of the pulsation damping member illustrated in FIG. 11 taken along line D-D.

FIG. 16 is a cross-sectional view of the pulsation damping member illustrated in FIG. 11 taken along line E-E.

FIG. 17 is a cross-sectional view of the pulsation damping member illustrated in FIG. 11 taken along line F-F.

FIG. 18 is a configuration diagram illustrating another configuration of the hydraulic control unit of the hydraulic brake system to which the present invention is applied.

### DESCRIPTION OF EMBODIMENTS

Next, embodiments of the present invention will be described in detail with reference to the accompanying drawings. Note that the present invention is not limited to the embodiments to be described below, and various modifications and application examples within the technical concept of the present invention are also included.

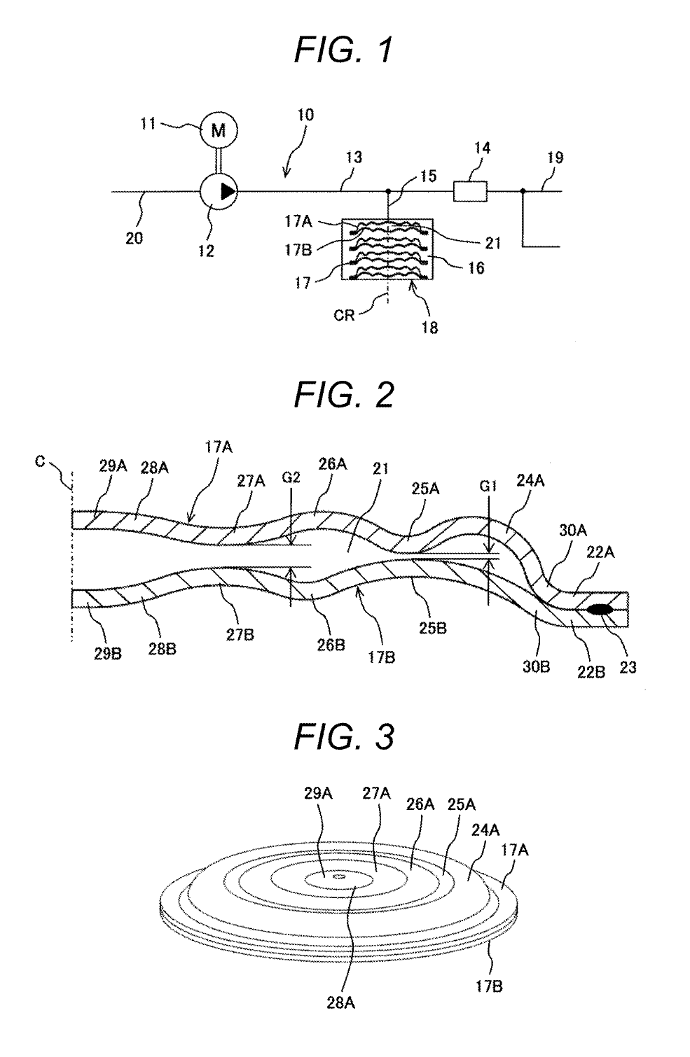

FIG. 1 illustrates a part of piping of a hydraulic system in a state where a pressure pulsation reducing device to which the present invention is applied is connected, and more particularly, a part of piping of a hydraulic control unit of a hydraulic brake system.

In FIG. 1, a hydraulic control unit 10 mainly includes an electric motor 11, a hydraulic pump 12 driven by the electric motor 11, an internal piping 13 to which a brake oil from the hydraulic pump 12 is supplied, a plurality of solenoid valves 14 that controls the brake oil in the internal piping 13, a branch pipe 15 branched from the internal piping 13, a fluid chamber 16 (pressure capacity chamber) connected to the branch pipe 15, and a plurality of pulsation damping member 17 disposed inside the fluid chamber 16. There is provided a pressure pulsation reducing device 18 including the fluid chamber 16 and the plurality of pulsation damping member 17. The solenoid valve 14 is connected to an external piping 19, and a wheel cylinder (not illustrated) of each wheel is connected to a tip of the external piping 19.

When a suction port of the hydraulic pump 12 sucks the brake oil from a suction piping 20, the brake oil is pressurized and discharged to the internal piping 13. The brake oil is accompanied by pressure pulsation, and the pressure pulsation needs to be damped to perform stable operation. Accordingly, the brake oil accompanied by the pressure pulsation is introduced into the fluid chamber 16 connected to the branch pipe 15, and the pressure pulsation is damped by the plurality of pulsation damping members 17 disposed inside the fluid chamber 16. That is, when a hydraulic pressure is applied to the pulsation damping member 17 including the metal diaphragm from the outside, relative positions of movable portions of the two metal diaphragms are displaced so that interior volume of the pulsation damping member 17 is changed, whereby the pressure pulsation of the brake oil inside the fluid chamber 16 is damped.

The pulsation damping member 17 is configured by a first metal diaphragm 17A and a second metal diaphragm 17B, which overlap each other, having corrugated shapes concentrically formed in a disc shape. The first metal diaphragm 17A and the second metal diaphragm 17B are fixed by welding at respective outer peripheral edge portions, and a sealed interior space 21 is formed between the first metal diaphragm 17A and the second metal diaphragm 17B.

In the pressure pulsation reducing device 18 of the hydraulic brake system configured as described above, durability becomes an issue as the number of operations increases as mentioned above. The pulsation damping member 17 is displaced in a direction in which the movable portions of the two metal diaphragms 17A and 17B move toward or away from each other in accordance with the pressure pulsation of the brake oil inside the fluid chamber, thereby entering a state where the volume of the interior space 21 of the pulsation damping member 17 is repeatedly increased/decreased. Accordingly, when a stress generated in the metal diaphragms 17A and 17B is large, the durability of the metal diaphragms 17A and 17B is seriously impaired. In addition, frequencies of displacement of the metal diaphragms 17A and 17B also largely affect an endurance period of the pulsation damping member. Therefore, it is required to improve the durability by minimizing the stress generated in the metal diaphragms 17A and 17B.

### First Embodiment

In view of the background as described above, a pressure pulsation reducing device having the following configuration is proposed in the present embodiment.

That is, in the present embodiment, the first metal diaphragm included in the pulsation damping member has a first recess portion drawn toward the interior space side, and the second metal diaphragm included in the pulsation damping member has a second recess portion drawn toward the interior space side, the second recess portion having a curvature larger than that of the first recess portion of the first metal diaphragm and being able to abut on the first recess portion of the first metal diaphragm.

In the present embodiment, a plurality of recess portions drawn toward the interior space side of the pulsation damping member is formed on one of the metal diaphragms included in the pulsation damping member while a plurality of recess portions drawn toward the interior space side of the pulsation damping member is formed on the other metal diaphragm included in the pulsation damping member, and when a predetermined pressure is applied to the two metal diaphragms, at least one recess portion of one of the metal diaphragms and at least one recess portion of the other metal diaphragm are in contact with each other.

Accordingly, when the predetermined pressure is applied, one recess portion drawn toward the interior space side between the two metal diaphragms are brought into contact with each other, whereby the stress of the two metal diaphragms can be reduced and the durability can be enhanced. Moreover, no special metal diaphragm is required so that an increase in product unit price can be suppressed.

Hereinafter, a configuration of the pressure pulsation reducing device according to the first embodiment of the present invention will be described in detail with reference to FIGS. 2 to 6.

FIG. 2 illustrates a partial cross section of the pulsation damping member 17 of the pressure pulsation reducing device 18. In FIG. 2, as the pulsation damping member 17 is formed in a substantially circular shape in a top view, a right half of the cross section with a center line as a boundary is illustrated. Further, FIG. 3 illustrates the pulsation damping member 17 viewed obliquely from above.

In FIGS. 2 and 3, the pulsation damping member 17 of the pressure pulsation reducing device 18 is formed in a substantially disc shape as a whole, and is configured by the first metal diaphragm 17A and the second metal diaphragm 17B, which overlap each other, having corrugated shapes concentrically formed around a central axis C. The first metal diaphragm 17A and the second metal diaphragm 17B are made of a stainless steel plate, which are low-priced and easy to use. As a result, the pulsation damping member 17 can be formed without using any special material.

In addition, the first metal diaphragm 17A and the second metal diaphragm 17B have an edge portion 22A and an edge portion 22B fixed by a welded portion 23, and a sealed interior space 21 is formed between the first metal diaphragm 17A and the second metal diaphragm 17B. The interior space 21 is maintained at a pressure not lower than atmospheric pressure.

Next, a shape of the first metal diaphragm 17A will be described. The first metal diaphragm 17A has a corrugated shape concentrically formed from the outer peripheral edge on the outside to the central axis C in succession. Here, in order to form the corrugated shape, “bent portions” projecting in directions opposite to each other are successively formed on the surface of the first metal diaphragm 17A, and those “bent portions” will be referred to as a projecting portion and a recess portion hereinafter.

Therefore, the first metal diaphragm 17A is provided with, from the outer peripheral edge on the outside, the edge portion 22A, a first projecting portion 24A projecting toward the opposite side of the interior space 21, a first recess portion 25A drawn toward the interior space 21 side, a second projecting portion 26A projecting toward the opposite side of the interior space 21, a second recess portion 27A drawn toward the interior space 21 side, a third projecting portion 28A projecting toward the opposite side of the interior space 21, and a flat portion 29A orthogonal to the central axis C.

Note that shapes of the respective projecting portions 24A, 26A, and 28A, and the respective recess portions 25A and 27A are determined to be smoothly connected. Further, the edge portion 22A and the first projecting portion 24A are connected to each other to be smoothly connected by a transition portion 30A. Furthermore, the second recess portion 27A and the flat portion 29A are connected to each other to be smoothly connected by the third projecting portion 28A.

Similarly, a shape of the second metal diaphragm 17B will be described. The second metal diaphragm 17B has a corrugated shape concentrically formed from the outer peripheral edge on the outside to the central axis C in succession. In order to form the corrugated shape, “bent portions” projecting in directions opposite to each other are formed on the surface of the second metal diaphragm 17B, and those “bent portions” will be referred to as a projecting portion and a recess portion hereinafter.

Therefore, the second metal diaphragm 17B is provided with, from the outer peripheral edge on the outside, the edge portion 22B, a first recess portion 25B drawn toward the interior space 21 side, a second projecting portion 26B projecting toward the opposite side of the interior space 21, a second recess portion 27B drawn toward the interior space 21 side, a third projecting portion 28B projecting toward the opposite side of the interior space 21, and a flat portion 29B orthogonal to the central axis C.

Note that shapes of the respective recess portions 25B and 27B, and the respective projecting portions 26B and 28B are determined to be smoothly connected. Further, the edge portion 22B and the first recess portion 25B are connected to each other to be smoothly connected by a transition portion 30B. Furthermore, the second recess portion 27B and the flat portion 29B are connected to each other to be smoothly connected by the third projecting portion 28B.

As a characteristic of the present embodiment, the first metal diaphragm 17A and the second metal diaphragm 17B have different curvatures of the projecting portion and the recess portion forming the corrugated shape. In other words, the respective projecting portions 24A, 26A, and 28A, and the respective recess portions 25A and 27A of the first metal diaphragm, and the respective recess portions 25B and 27B, and the respective projecting portions 26B and 28B of the second metal diaphragm 17B are formed in an arc shape having different curvatures in sectional shapes.

Next, the curvature of each of the projecting portions and the recess portions will be described. With respect to the first metal diaphragm 17A, there are provided the edge portion 22A, the transition portion 30A, the first projecting portion 24A, the first recess portion 25A, the second projecting portion 26A, the second recess portion 27A, and the third projecting portion 28A in the order from the outer edge to the center. The curvatures of the respective projecting portions 24A, 26A, and 28A, and the respective recess portions 25A and 27A are appropriately set so that those portions are smoothly connected to satisfy the following relationship.

Similarly, with respect to the second metal diaphragm 17B, there are provided the edge portion 22B, the transition portion 30B, the first recess portion 25B, the second projecting portion 26B, the second recess portion 27B, and the third projecting portion 28B in the order from the outer edge to the center. The curvatures of the respective recess portions 25B and 27B, and the respective projecting portions 26B and 28B are appropriately set so that those portions are smoothly connected to satisfy the following relationship.

First, the curvature of the transition portion 30B of the second metal diaphragm 17B is set to be larger than that of the transition portion 30A of the first metal diaphragm 17A so that a first predetermined distance G1 is kept in the vicinity of each apex of the first recess portion 25A of the first metal diaphragm 17A and the first recess portion 25B of the second metal diaphragm 17B.

Further, the curvature of the first recess portion 25B of the second metal diaphragm 17B is set to be larger than the curvature of the first projecting portion 24A and the first recess portion 25A of the first metal diaphragm 17A. In the present embodiment, the curvature of the first recess portion 25B of the second metal diaphragm 17B is set to, for example, twice or more the curvature of the first recess portion 25A of the first metal diaphragm 17A.

Furthermore, the curvatures of the second projecting portion 26A of the first metal diaphragm 17A, the second projecting portion 26B of the second metal diaphragm 17B, the second recess portion 27A of the first metal diaphragm 17A, and the second recess portion 27B of the second metal diaphragm 17B are set to be substantially similar so that a second predetermined distance G2 is kept in the vicinity of the apexes of the second recess portion 27A of the first metal diaphragm 17A and the second recess portion 27B of the second metal diaphragm 17B.

Here, the second predetermined distance G2 in the vicinity of the apexes of the second recess portion 27A of the first metal diaphragm 17A and the second recess portion 27B of the second metal diaphragm 17B is set to be larger than the first predetermined distance G1 in the vicinity of each apex of the first recess portion 25A of the first metal diaphragm 17A and the first recess portion 25B of the second metal diaphragm 17B.

The relationship represented by the second predetermined distance G2>the first predetermined distance G1 is set so that the recess portions of each of the two metal diaphragms 17A and 17B successively deform to come into contact with each other from the outer peripheral side toward the central axis C when a pressure is applied to the two metal diaphragms 17A and 17B.

Therefore, when a first set pressure P1 is applied to the two metal diaphragms 17A and 17B, the vicinities of the respective apexes of the first recess portion 25A of the first metal diaphragm 17A and the first recess portion 25B of the second metal diaphragm 17B are brought into contact with each other, and when a second set pressure P2 larger than the first set pressure P1 is applied thereafter, the vicinities of the apexes of the second recess portion 27A of the first metal diaphragm 17A and the second recess portion 27B of the second metal diaphragm 17B deform to come into contact with each other.

Returning to FIG. 1, a fluid chamber 16 is a cylindrically shaped container sealed at both ends thereof, and a central axis CR of the fluid chamber 16 is determined to be coincident with a direction in which a brake oil flows into the fluid chamber 16 (vertical direction in FIG. 1). The central axis C of a plurality of pulsation damping members 17 is disposed to be coincident with the central axis CR of the fluid chamber 16.

Next, operation of the pressure pulsation reducing device 18 will be described. When an electric motor 11 drives a hydraulic pump 12, the brake oil is sucked from a suction piping 20, and the pressurized brake oil is discharged to an external piping 19 through an internal piping 13 and a plurality of solenoid valves 14. At this time, a pressure due to the brake oil is applied to the fluid chamber 16 through a branch pipe 15. As described above, the pulsation damping member 17 provided inside the fluid chamber 16 includes the two metal diaphragms 17A and 17B, and the interior space 21 is formed between the diaphragms 17A and 17B.

Therefore, in a case where pressure pulsation occurs in the brake oil, the interior space 21 of the pulsation damping member 17 is compressed to operate such that the brake oil of the internal piping 13 is sucked into the fluid chamber 16 when a hydraulic pressure of the brake oil applied to the inside of the fluid chamber 16 is high. On the other hand, when the hydraulic pressure of the brake oil in the fluid chamber 16 is low, the interior space 21 of the pulsation damping member 17 expands to operate such that the brake oil inside the fluid chamber 16 is returned to the internal piping 13.

That is, when the pressure inside the fluid chamber 16 increases, the first metal diaphragm 17A and the second metal diaphragm 17B deform toward the interior space 21 side, and a deformation occurs in such a manner that the volume of the interior space 21 eventually decreases. When the pressure inside the fluid chamber 16 decreases to the contrary, the first metal diaphragm 17A and the second metal diaphragm 17B return to their original shapes, and a deformation occurs in such a manner that the decreased volume of the interior space 21 increases.

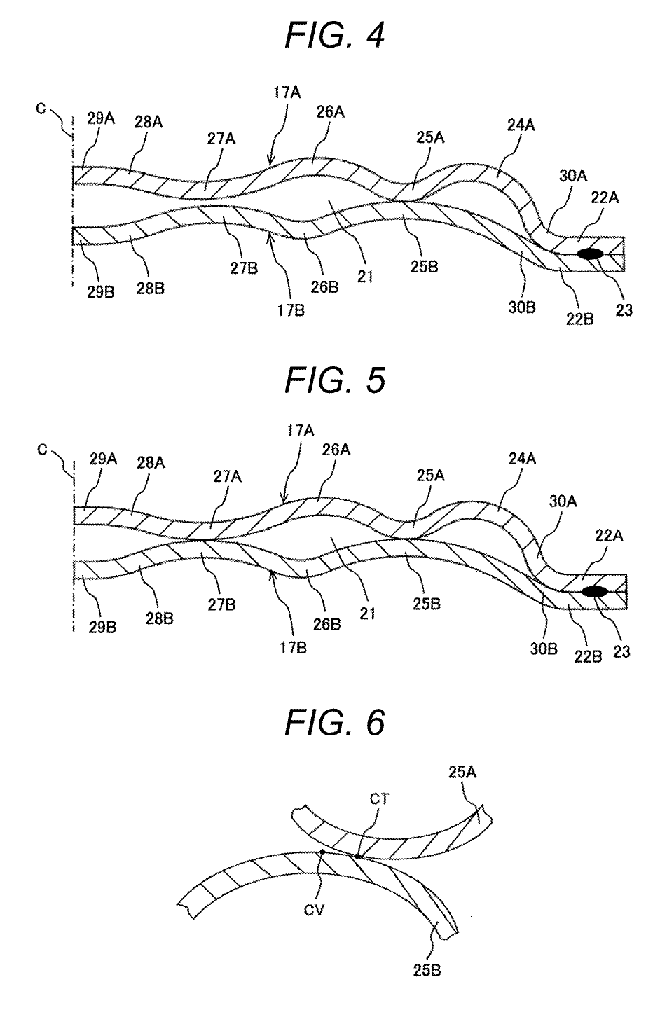

This behavior will be described in more detail with reference to FIGS. 4 and 5. In this case, a state in which a pressure is applied to the outer surfaces of the first metal diaphragm 17A and the second metal diaphragm 17B is described. FIG. 4 illustrates a state in which the first set pressure P1 is applied to the outer surfaces of the first metal diaphragm 17A and the second metal diaphragm 17B. FIG. 5 illustrates a state in which the second set pressure P2 larger than the first set pressure P1 is applied to the outer surfaces of the first metal diaphragm 17A and the second metal diaphragm 17B.

First, in FIG. 4, when a brake hydraulic pressure inside the fluid chamber 16 starts to increase, the first metal diaphragm 17A and the second metal diaphragm 17B as a whole deform toward the interior space 21 side.

In general, as the curvature of the “bent portions” including the projecting portion and the recess portion is larger, the metal diaphragm in the corrugated shape is more likely to deform, whereby a large deformation can be obtained with the same stress. Accordingly, when the hydraulic pressure is applied by the brake oil, since the curvature of the first recess portion 25B of the second metal diaphragm 17B is larger than the curvature of the first recess portion 25A of the first metal diaphragm 17A up to the first set pressure P1, the first recess portion 25B can obtain a large deformation amount with a small stress. Meanwhile, since the curvature of the first recess portion 25A is small, it has a shape hardly deformable and the stress of the first recess portion 25A becomes small.

When the pressure in the fluid chamber 16 reaches the first set pressure P1 as the pressure increases, the first recess portion 25A of the first metal diaphragm 17A and the first recess portion 25B of the second metal diaphragm 17B move the first predetermined distance G1 to come into contact with each other. Meanwhile, the second recess portion 27A of the first metal diaphragm 17A and the second recess portion 27B of the second metal diaphragm 17B do not move the second predetermined distance G2, and are not in contact with each other. In this state, the first recess portion 25A of the first metal diaphragm 17A and the first recess portion 25B of the second metal diaphragm 17B come into contact with each other to support each other, whereby the stress of the first projecting portion 24A of the first metal diaphragm 17A does not increase.

Then, when the pressure further increases from the first set pressure P1, since the first recess portion 25A of the first metal diaphragm 17A and the first recess portion 25B of the second metal diaphragm 17B are in contact with each other, the first projecting portion 24A and the first recess portion 25A of the first metal diaphragm 17A and the first recess portion 25B of the second metal diaphragm 17B are hardly deformed. Meanwhile, the second projecting portion 26A, the second recess portion 27A, the third projecting portion 28A, and the flat portion 29A of the first metal diaphragm 17A, and the second projecting portion 26B, the second recess portion 27B, the third projecting portion 28B, and the flat portion 29B of the second metal diaphragm 17B continue to deform toward the interior space 21 side.

In this state (between the first set pressure P1 and the second set pressure P2), the radius of the second recess portion 27A of the first metal diaphragm 17A and the second recess portion 27B of the second metal diaphragm 17B is relatively large viewed from the contact point of the first recess portion 25A and the first recess portion 25B, whereby a large deformation amount can be obtained with a small stress.

Then, as illustrated in FIG. 5, when the pressure reaches the second set pressure P2, the second recess portion 27A of the first metal diaphragm 17A and the second recess portion 27B of the second metal diaphragm 17B move the second predetermined distance G2 to come into contact with each other. Further, even when the pressure further increases after the second recess portion 27A of the first metal diaphragm 17A and the second recess portion 27B of the second metal diaphragm 17B are brought into contact with each other, the first recess portion 25A and the first recess portion 25B are in contact with each other, and the second recess portion 27A and the second recess portion 27B are in contact with each other likewise, whereby the first metal diaphragm 17A and the second metal diaphragm 17B are difficult to deform further.

When the second set pressure P2 is reached, the first recess portion 25A of the first metal diaphragm 17A and the first recess portion 25B of the second metal diaphragm 17B come into contact with each other, and also the second recess portion 27A of the first metal diaphragm 17A and the second recess portion 27B of the second metal diaphragm 17B come into contact with each other to support each other, whereby the stress of the first projecting portion 24A, the first recess portion 25A, and the second recess portion 27A of the first metal diaphragm 17A, and the first recess portion 25B and the second recess portion 27B of the second metal diaphragm 17B does not increase so much.

Likewise, even when the brake hydraulic pressure is equal to or more than the second set pressure P2, the configuration in which the first recess portion 25A and the first recess portion 25B are in contact with each other and the second recess portion 27A and the second recess portion 27B are in contact with each other is maintained, whereby the stress of the first projecting portion 24A, the first recess portion 25A, and the second recess portion 27A of the first metal diaphragm 17A, and the first recess portion 25B and the second recess portion 27B of the second metal diaphragm 17B does not increase so much.

When viewed from each contact point, the radius of the transition portion 30A of the first metal diaphragm 17A and the transition portion 30B of the second metal diaphragm 17B, the second projecting portion 26A of the first metal diaphragm 17A and the second projecting portion 26B of the second metal diaphragm 17B, and the third projecting portion 28A of the first metal diaphragm 17A and the third projecting portion 28B of the second metal diaphragm 17B is small, whereby it is hardly deformable and the stress is small.

For that reason, the stress of the pulsation damping member 17 is made small so that it becomes possible to improve the durability and achieve downsizing. Moreover, no metal diaphragm made of a special material is required so that an increase in product unit price can be suppressed.

Here, the pressure at which the first recess portion 25A and the first recess portion 25B come into contact with each other is set as the first set pressure P1, and the pressure at which the second recess portion 27A and the second recess portion 27B come into contact with each other is set as the second set pressure P2. The first set pressure P1 can be adjusted by appropriately setting the curvatures of the first recess portion 25A and the first recess portion 25B. Likewise, the second set pressure P2 can be adjusted by appropriately setting the curvatures of the second recess portion 27A and the second recess portion 27B.

It is preferable to set the first set pressure P1 to be smaller than the second set pressure P2, and to set the second set pressure P2 to be larger than the maximum value of the pressure in which pressure pulsation needs to be damped and to be smaller than the maximum operation pressure of a hydraulic control unit (hydraulic pressure control unit) of a hydraulic brake system.

As described above, due to the deformation of the pulsation damping member 17 including the first metal diaphragm 17A and the second metal diaphragm 17B, the brake oil in the internal piping 13 is sucked into the fluid chamber 16 when the brake hydraulic pressure in the fluid chamber 16 is high, and the brake oil inside the fluid chamber 16 is returned to the internal piping 13 when the brake hydraulic pressure in the fluid chamber 16 is low, whereby the pressure pulsation of the brake oil is damped and the brake hydraulic pressure can be stabilized.

Further, the first metal diaphragm 17A and the second metal diaphragm 17B are provided with the first recess portion 25A and the first recess portion 25B, and the second recess portion 27A and the second recess portion 27B projecting toward the interior space 21 side at positions facing each other so that the contact positions of the metal diaphragms can be set clearly and easily, whereby the respective metal diaphragms can be produced at a low unit cost.

As illustrated in FIG. 6, an abutting point CT of the first recess portion 25A of the first metal diaphragm 17A and the first recess portion 25B of the second metal diaphragm 17B is set on the outer peripheral side of an apex CV of the first recess portion 25B of the second metal diaphragm 17B to obtain the following advantages. That is, when a pressure higher than the second set pressure P2 is applied to the first metal diaphragm 17A and the second metal diaphragm 17B, compared with component force in the direction toward the outer peripheral side received by the first recess portion 25B of the second metal diaphragm 17B, reaction force received from the contact point CT is large, whereby force to the welded portion 23 as a fixed portion becomes small. Therefore, the stress of the welded portion becomes small so that the durability of the welded portion 23 can be improved.

In the present embodiment, there has been described the pulsation damping member 17 in which two recess portions (bent portions) drawn toward the interior space 21 side are provided on each of the first metal diaphragm 17A and the second metal diaphragm 17B and the two recess portions are brought into contact with each other when the brake hydraulic pressure is applied. However, one or more bent portions drawn toward the interior space 21 side may be formed on each of the first metal diaphragm 17A and the second metal diaphragm 17B. When two or more bent portions (e.g., two to five bent portions) are formed, it is important to successively bring into contact from the outer peripheral side.

### Second Embodiment

Next, a second embodiment of the present invention will be described. It is basically the same as in the first embodiment, and the difference is that an edge portion on an outer peripheral side is folded back to one side surface.

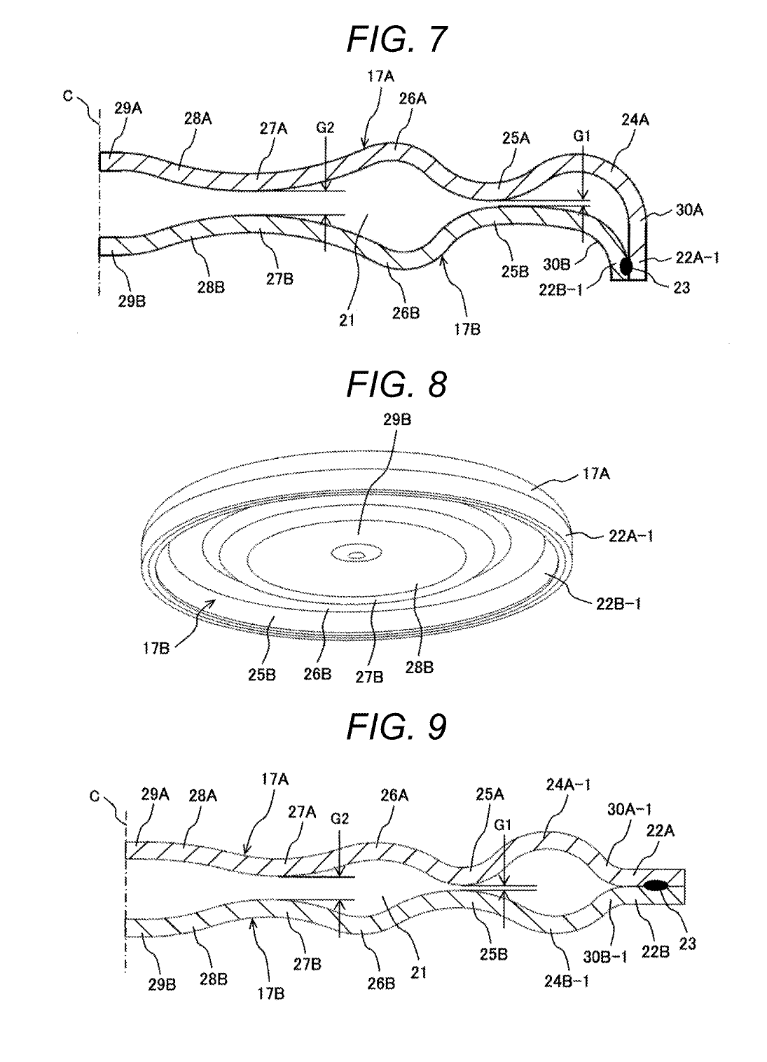

Hereinafter, a configuration of a pulsation damping member according to the second embodiment will be described with reference to FIGS. 7 and 8. FIG. 7 illustrates a cross section of a pulsation damping member 17, and FIG. 8 illustrates the pulsation damping member viewed obliquely from a lower side. In the second embodiment, basic structures such as a first recess portion 25A and a second recess portion 27A of a first metal diaphragm 17A, and a first recess portion 25B and a second recess portion 27B of a second metal diaphragm 17B are the same structures as in the first embodiment. Configurations of an edge portion 22A-1 of the first metal diaphragm 17A and an edge portion 22B-1 of the second metal diaphragm 17B are different from the first embodiment. Note that the same parts as those in the first embodiments are denoted by the same reference signs, and the overlapping descriptions are omitted.

In FIGS. 7 and 8, the edge portion 22A-1 (tangential line of the first projecting portion 24A) extending from the first projecting portion 24A of the first metal diaphragm 17A is formed to be in parallel with a central axis C. The edge portion 22A-1 is formed in a tubular shape when viewed as a whole, and is connected to the first projecting portion 24A. Further, the edge portion 22B-1 (tangential line of the first recess portion 25B) extending from the first recess portion 25B of the second metal diaphragm 17B is formed to be in parallel with the central axis C. The edge portion 22B-1 is also formed in a tubular shape when viewed as a whole, and is connected to the first recess portion 25B. The edge portion 22A-1 of the first metal diaphragm 17A and the edge portion 22B-1 of the second metal diaphragm 17B overlap, and are fixed by a welded portion 23. Operation of the pulsation damping member 17 having such a configuration is similar to that in the first embodiment, and the descriptions thereof will be omitted.

Here, the curvature of the first recess portion 25B of the second metal diaphragm 17B is larger than the curvatures of the first projecting portion 24A and the first recess portion 25A of the first metal diaphragm 17A. Therefore, even when a projecting portion projecting toward the opposite side of an interior space 21 is not provided between the first recess portion 25B and the edge portion 22B-1 of the second metal diaphragm 17B, the edge portion 22B-1 and the edge portion 22A-1 can be brought into contact with each other.

Accordingly, the number of projecting portions projecting toward the opposite side of the interior space 21 of the first metal diaphragm 17A is different from the number of number of projecting portions projecting toward the opposite side of the interior space 21 of the second metal diaphragm 17B. In the present embodiment, the number of the projecting portions projecting toward the opposite side of the interior space 21 of the first metal diaphragm 17A is larger.

In the second embodiment as well, substantially the same effect as in the first embodiment can be obtained. As a different effect other than that, since the radius of the pulsation damping member 17 can be made short compared with that in the first embodiment, a pressure pulsation reducing device compact in a radial direction can be achieved.

### Third Embodiment

Next, a third embodiment of the present invention will be described. It is basically the same as in the first embodiment, and the difference is that a first projecting portion is formed on a second metal diaphragm.

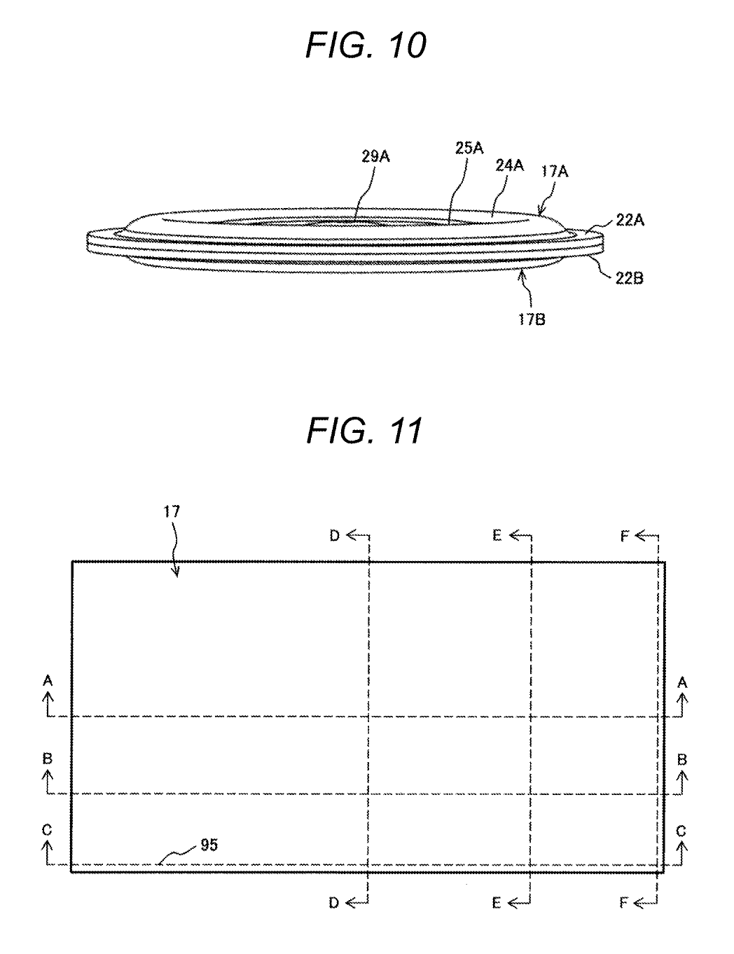

Hereinafter, a configuration of a pulsation damping member according to the third embodiment will be described with reference to FIGS. 9 and 10. FIG. 9 illustrates a cross section of a pulsation damping member 17, and FIG. 10 illustrates the pulsation damping member viewed obliquely from an upper side. In the third embodiment, basic structures such as a first recess portion 25A and a second recess portion 27A of a first metal diaphragm 17A, and a first recess portion 25B and a second recess portion 27B of a second metal diaphragm 17B are the same structures as in the first embodiment. Shapes from an edge portion 22A to the first recess portion 25A of the first metal diaphragm 17A, and from an edge portion 22B to the first recess portion 25b of the second metal diaphragm 17B are different from those in the first embodiment. Note that the same parts as those in the first embodiments are denoted by the same reference signs, and the overlapping descriptions are omitted.

In FIGS. 9 and 10, the edge portion 22A orthogonal to a central axis C is formed on the outer periphery of the first metal diaphragm 17A, a transition portion 30A-1 curved upward in FIG. 9 from the edge portion 22A is formed, and a first projecting portion 24A-1 projecting toward an opposite side of an interior space 21 from the transition portion 30A-1 is further formed.

Likewise, the edge portion 22B orthogonal to the central axis C is formed on the outer periphery of the second metal diaphragm 17B, a transition portion 30B-1 curved downward in FIG. 9 from the edge portion 22B is formed, and a first projecting portion 24B-1 projecting toward the opposite side of the interior space 21 from the transition portion 30B-1 is further formed.

Here, a curvature of the transition portion 30A-1 is set so that the edge portion 22A and the first projecting portion 24A-1 can be smoothly connected. Likewise, a curvature of the transition portion 30B-1 is set so that the edge portion 22B and the first projecting portion 24B-1 can be smoothly connected. Operation of the pulsation damping member 17 having such a configuration is similar to that in the first embodiment, and the descriptions thereof will be omitted.

In the third embodiment as well, substantially the same effect as in the first embodiment can be obtained. As a different effect other than that, since the inclination of the transition portions 30A-1 and 30B-1 is small, the height of the pulsation damping member 17 can be made low compared with that in the first embodiment, whereby a pressure pulsation reducing device compact in an axial direction can be achieved.

### Fourth Embodiment

Next, a fourth embodiment of the present invention will be described. It is basically the same as in the first embodiment. The difference is that a pulsation damping member according to the fourth embodiment uses a substantially rectangular metal diaphragm while the pulsation damping member according to the first embodiment uses a substantially circular metal diaphragm.

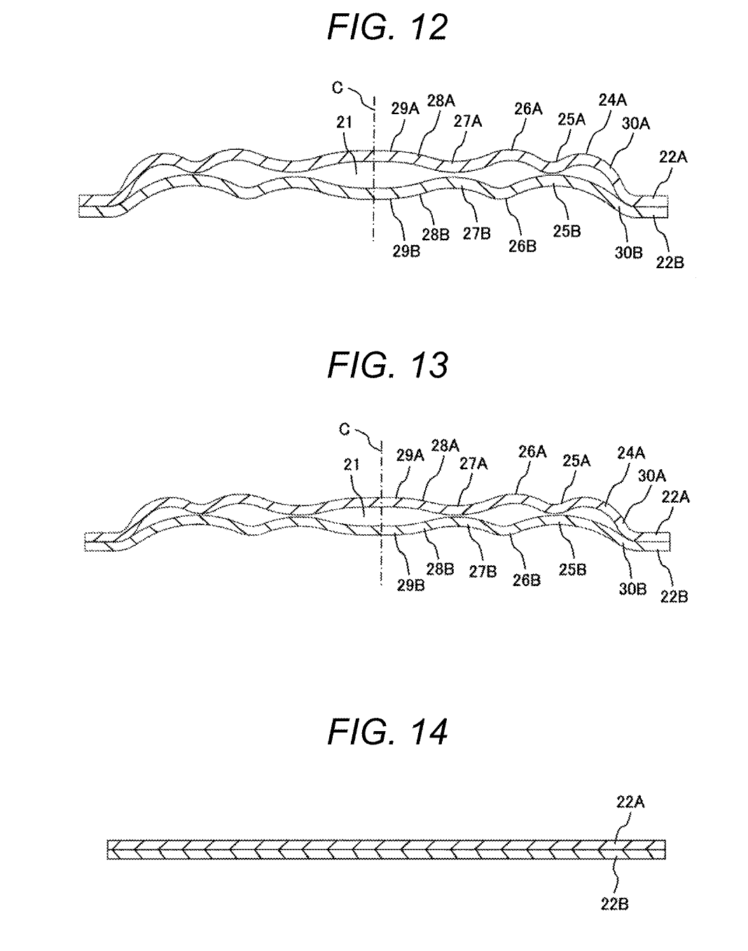

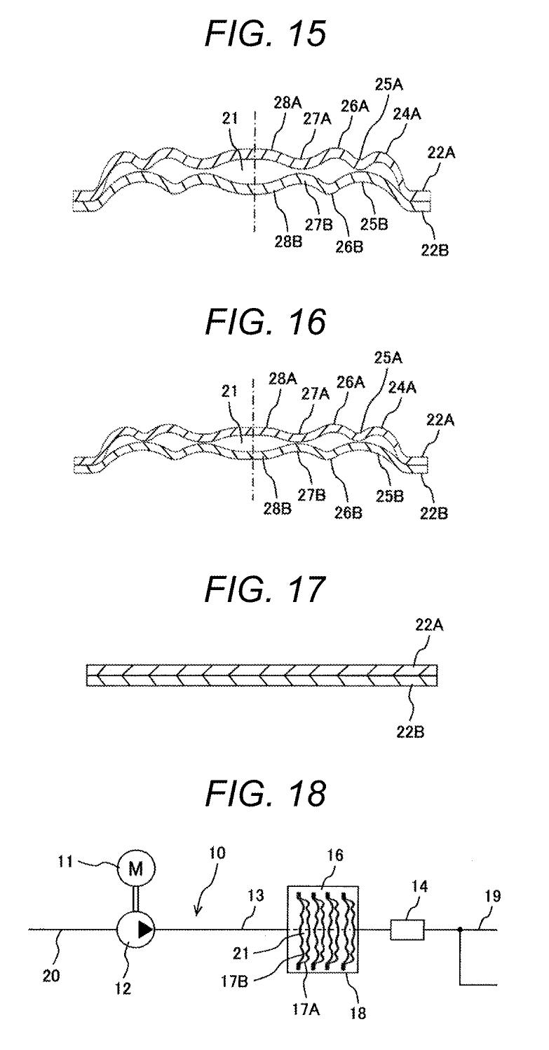

Hereinafter, a configuration of the pulsation damping member according to the fourth embodiment will be described with reference to FIGS. 11 to 17. FIG. 11 illustrates an upper surface of the pulsation damping member viewed from above, FIG. 12 illustrates a cross section taken along line A-A in FIG. 11, FIG. 13 illustrates a cross section taken along line B-B in FIG. 11, FIG. 14 illustrates a cross section taken along line C-C in FIG. 11, FIG. 15 illustrates a cross section taken along line D-D in FIG. 11, FIG. 16 illustrates a cross section taken along line E-E in FIG. 11, and FIG. 17 illustrates a cross section taken along line F-F in FIG. 11. Note that the same parts as those in the first embodiments are denoted by the same reference signs, and the overlapping descriptions are omitted.

In FIGS. 11 to 17, a pulsation damping member 17 is configured by overlapping edge portions 22A and 22B formed by sides of a first metal diaphragm 17A and a second metal diaphragm 17B formed in a rectangular shape.

As illustrated in FIGS. 12 to 14, the shape of each long side of the first metal diaphragm 17A and the second metal diaphragm 17B gradually changes in the order of FIG. 12, FIG. 13, and FIG. 14. As can be seen from the drawings, basic shapes of the cross sections of the first metal diaphragm 17A and the second metal diaphragm 17B are substantially the same as the shape described in the first embodiment.

Further, as illustrated in FIGS. 15 to 17, the shape of each short side of the first metal diaphragm 17A and the second metal diaphragm 17B gradually changes in the order of FIG. 15, FIG. 16, and FIG. 17. Likewise, as can be seen from the drawings, the basic shapes of the cross sections of the first metal diaphragm 17A and the second metal diaphragm 17B are substantially the same as the shape described in the first embodiment. Operation of the pulsation damping member 17 having such a configuration is similar to that in the first embodiment, and the descriptions thereof will be omitted.

In the fourth embodiment as well, substantially the same effect as in the first embodiment can be obtained. As a different effect other than that, since an area of the rectangular pulsation damping member can be made larger than that of the circular pulsation damping member compared with the first embodiment, the pulsation damping effect can be improved. Furthermore, since an interior space of a hydraulic control unit 10 of a hydraulic brake system is formed in a rectangular shape, when a fluid chamber is formed to be rectangular, the space can be utilized more effectively than a circular fluid chamber as in the first embodiment.

Although the hydraulic control unit 10 described above connects a pressure pulsation reducing device 18 via a branch pipe 15, it can also be applied to the pressure pulsation reducing device 18 having the configuration illustrated in FIG. 18. In FIG. 18, the pressure pulsation reducing device 18 is disposed in series relative to an internal piping 13, and a center line of a fluid chamber 16 is made to be coincident with the direction in which a brake oil flows. A plurality of the pulsation damping member 17 is disposed in the fluid chamber 16, and central axes of the respective pulsation damping members 17 are disposed to be in coincident with and to overlap the central axis of the fluid chamber 16. Even in such a configuration, the configuration described in each embodiment can be adopted.

As described above, according to the present invention, the first metal diaphragm included in the pulsation damping member has a first recess portion drawn toward the interior space side, and the second metal diaphragm included in the pulsation damping member has a first recess portion drawn toward the interior space side, the first recess portion having a curvature larger than that of the first recess portion and being able to abut on the first recess portion.

Moreover, according to the present invention, a plurality of recess portions drawn toward the interior space side of the pulsation damping member is formed on one of the metal diaphragms included in the pulsation damping member while a plurality of recess portions drawn toward the interior space side of the pulsation damping member is formed on the other metal diaphragm included in the pulsation damping member, and when a predetermined pressure is applied to the two metal diaphragms, at least one recess portion of one of the metal diaphragms and at least one recess portion of the other metal diaphragm are in contact with each other.

According to such a configuration, when the predetermined pressure is applied, one recess portion projecting toward the interior space side between the two metal diaphragms are brought into contact with each other, whereby the stress of the two metal diaphragms can be reduced and the durability can be enhanced. Moreover, no metal diaphragm made of a special material is required so that an increase in product unit price can be suppressed.

Although the hydraulic brake system has been exemplified in the descriptions above, the present invention is not limited thereto, and can be adopted for pressure pulsation reducing devices and pulsation damping members of various hydraulic systems.

The present invention is not limited to the embodiments described above, and includes various modifications. For example, the above-described embodiments have been described in detail for convenience of describing the present invention in a manner easy to understand, and are not necessarily limited to those having all the described configurations. A configuration of one embodiment may be partially replaced with a configuration of another embodiment, and the configuration of another embodiment may be added to the configuration of one embodiment.

### REFERENCE SIGNS LIST

10 hydraulic control unit
11 electric motor
12 hydraulic pump
13 internal piping
14 solenoid valve
15 branch pipe
16 branch pipe
17 pulsation damping member
17A first metal diaphragm
17B second metal diaphragm
18 pressure pulsation reducing device
24A first projecting portion
25A, 25B first recess portion
26A, 26B second projecting portion
27A, 27B second recess portion
28A, 28B third projecting portion
29A, 29B flat portion

1. A pressure pulsation reducing device of a hydraulic system, the pressure pulsation reducing device storing, inside a fluid chamber connected to piping of the hydraulic system, one or more pulsation damping member formed of a first metal diaphragm and a second metal diaphragm and provided with an interior space formed between the metal diaphragms, wherein
the first metal diaphragm has a first recess portion drawn toward the interior space side,
the second metal diaphragm has a first recess portion drawn toward the interior space side, the first recess portion having a curvature larger than a curvature of the first recess portion and being able to abut on the first recess portion of the first metal diaphragm, and
in a case where a pressure inside the fluid chamber reaches a first predetermined set pressure, the first recess portion of the first metal diaphragm and the first recess portion of the second metal diaphragm are brought into contact with each other.

2. The pressure pulsation reducing device of a hydraulic system according to claim 1, wherein
the first metal diaphragm has a second recess portion provided on a central axis side of the first recess portion of the first metal diaphragm and drawn toward the interior space side,
the second metal diaphragm has a second recess portion provided on the central axis side of the first recess portion of the second metal diaphragm and drawn toward the interior space side, and
in a case where the pressure inside the fluid chamber reaches a second predetermined set pressure larger than the first set pressure, the second recess portion of the first metal diaphragm and the second recess portion of the second metal diaphragm are brought into contact with each other.

3. The pressure pulsation reducing device of a hydraulic system according to claim 2, wherein
the first recess portion of the first metal diaphragm and the first recess portion of the second metal diaphragm come into contact with each other on an edge portion side of the second metal diaphragm from an apex of the first recess portion of the second metal diaphragm.

4. A pressure pulsation reducing device of a hydraulic control system, the pressure pulsation reducing device storing, inside a fluid chamber connected to piping of the hydraulic control system, one or more pulsation damping member formed of two metal diaphragms and provided with an interior space formed between the metal diaphragms, wherein
a plurality of recess portions drawn toward the interior space of the pulsation damping member is formed on one of the metal diaphragms included in the pulsation damping member,
a plurality of recess portions drawn toward the interior space of the pulsation damping member is formed on another metal diaphragm included in the pulsation damping member, and
in a case where a predetermined pressure is applied to the two metal diaphragms, at least one of the recess portions of one of the metal diaphragms and at least one of the recess portions of the other metal diaphragm are brought into contact with each other.

5. The pressure pulsation reducing device of a hydraulic system according to claim 4, wherein
as a pressure inside the fluid chamber increases, the plurality of recess portions formed on the two metal diaphragms is successively brought into contact with each other from an outer peripheral side toward a center of the two metal diaphragms.

6. A pulsation damping member damping pressure pulsation of a hydraulic system, formed of a first metal diaphragm and a second metal diaphragm, and provided with an interior space formed between the metal diaphragms, wherein
the first metal diaphragm has a first recess portion drawn toward the interior space side,
the second metal diaphragm has a first recess portion drawn toward the interior space side, the first recess portion having a curvature larger than a curvature of the first recess portion and being able to abut on the first recess portion of the first metal diaphragm, and
in a case where a pressure applied to an outer surface of the first metal diaphragm and the second metal diaphragm reaches a first set pressure, the first recess portion of the first metal diaphragm and the first recess portion of the second metal diaphragm are brought into contact with each other.

7. The pulsation damping member according to claim 6, wherein
the first metal diaphragm has a second recess portion provided on a central axis side of the first recess portion of the first metal diaphragm and drawn toward the interior space side,
the second metal diaphragm has a second recess portion provided on the central axis side of the first recess portion of the second metal diaphragm and drawn toward the interior space side, and
in a case where the pressure applied to the outer surface of the first metal diaphragm and the second metal diaphragm reaches a second predetermined set pressure larger than the first set pressure, the second recess portion of the first metal diaphragm and the second recess portion of the second metal diaphragm are brought into contact with each other.

8. The pulsation damping member according to claim 7, wherein
the first recess portion of the first metal diaphragm and the first recess portion of the second metal diaphragm come into contact with each other on an edge portion side of the second metal diaphragm from an apex of the first recess portion of the second metal diaphragm.
